(19) United States
(12) Patent Application Publication
(10) Pub. No.: US 2026/0332520 A1
(43) Pub. Date: Oct. 22, 2026

(54) COMMUNICATION SYSTEM FOR COORDINATING DATA STREAMS

(71) Applicant: Schweitzer Engineering Laboratories, Inc., Pullman, WA (US)

(72) Inventors: Eric J. Hewitt, Moscow, ID (US); Paul Gentry, Seattle, WA (US); Aleksandr A. Zemlyanskiy, Mill Creek, WA (US)

(73) Assignee: Schweitzer Engineering Laboratories, Inc., Pullman, WA (US)

(21) Appl. No.: 19/180,371

(22) Filed: Apr. 16, 2025

(51) Int. Cl. H04L 45/42; H04L 45/52; H04L 67/12

(52) U.S. Cl. CPC H04L 45/42; H04L 45/52; H04L 67/12

(57) ABSTRACT

Communication systems for routing data streams between multiple data publishers and data subscribers are described. In one embodiment, a communication system includes a communication interface to receive a plurality of data streams from the plurality of data publishers over time, each of the plurality of data streams comprising a plurality of data values. A data routing subsystem generates a data block for one at least one of the plurality of data subscribers. The data block includes data values from one or more of the plurality of data publishers. The data block may accumulate values until a condition triggers routing the data block to a data subscriber.

### RELATED APPLICATIONS

None

### TECHNICAL FIELD

This disclosure relates to routing data streams from publishers to subscribers. More particularly, but not exclusively, the present disclosure relates to improving efficiency in communicating multiple streams of multi-rate signal data between publishers and subscribers.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates a conceptual representation of a communication system consistent with embodiments of the present disclosure.

FIG. 2 illustrates a functional block diagram of a communication system for routing data from a plurality of data publishers to a plurality of data subscribers consistent with embodiments of the present disclosure.

FIG. 3 illustrates a flow chart of a method for routing data from a plurality of data publishers to a plurality of destinations consistent with embodiments of the present disclosure.

The following description provides numerous specific details for a thorough understanding of the various embodiments disclosed herein. However, those skilled in the art will recognize that the systems and methods disclosed herein can be practiced without one or more specific details, or with other methods, components, materials, etc. In addition, in some cases, well-known structures, materials, or operations may not be shown or described in detail to avoid obscuring aspects of the disclosure. Furthermore, the described features, structures, or characteristics may be combined in any suitable manner in one or more alternative embodiments.

### DETAILED DESCRIPTION

Various embodiments consistent with the present disclosure may connect data producers, typically referred to as data publishers, and data consumers, typically referred to as data subscribers, via a unified interface. Industrial systems, in particular, may generate and consume large amounts of data, much of which may comprise machine-to-machine communications. For example, an electric power system may incorporate equipment that monitors voltages, currents, frequencies, and other parameters related to the production, transmission, distribution, and utilization of electrical energy. These measurements may be utilized by devices that monitor, automate, and protect the electric power system.

Various factors may contribute to the difficulty in routing communications within applicable constraints. Data publishers in an electric power system may be subject to various requirements (e.g., latency requirements) and span a considerable range of signal rates (e.g., less than 1 Hz to over 1 MHz or greater). Routing communications in such systems may be complicated because some communication streams may be routed from a single data publisher to multiple data subscribers, while other streams are routed only between two devices. Further, in some embodiments, it may be beneficial to avoid coupling data publishers and data subscribers to one another.

A communication system consistent with the present disclosure may offer a variety of advantages for streamlining and simplifying communication between a plurality of data publishers and data subscribers. One such advantage may include improving network utilization by consolidating information from publishers before transmitting such information to a data subscriber. Data destined for a data publisher may be grouped into the largest packets within applicable requirements to decrease network transit overhead. Further, in some embodiments, redundant data may be reduced or eliminated. Another advantage may include offering a consistent interface to a variety of devices. A consistent interface may facilitate the configuration of devices from different manufacturers or configurations. Another advantage includes enabling high availability and scalability. Other advantages are discussed below and will be apparent to one of skill in the art.

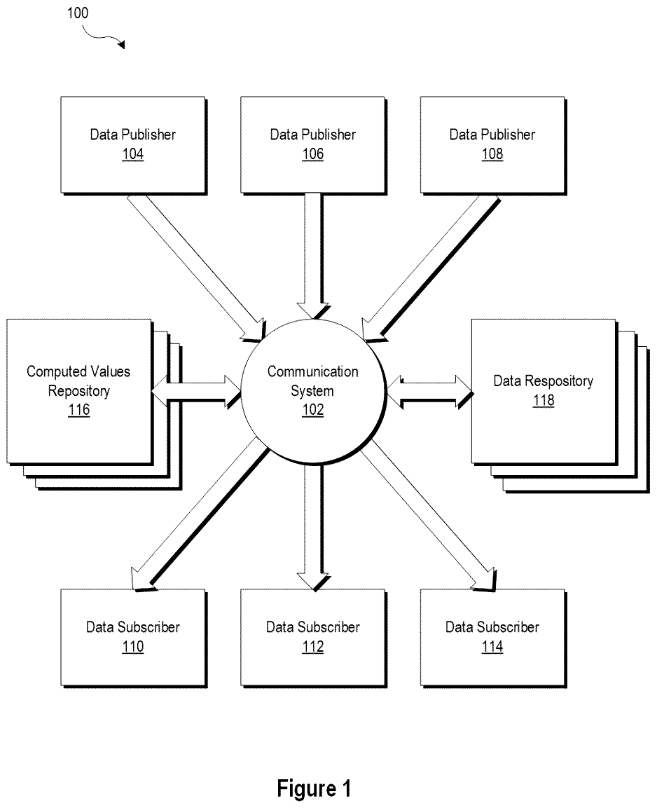

FIG. 1 illustrates a high-level diagram of a system 100 for routing data streams from a plurality of data publishers 104, 106, and 108 to a plurality of subscribers 110, 112, and 114 consistent with embodiments of the present disclosure. Data streams are represented as arrows between various elements. For example, data publishers 104, 106, and 108 are each at the end of an arrow pointing toward communication system 102. The direction of the arrows may indicate the primary (not exclusive) direction of data flow. The data created by data publishers 104, 106, and 108 may be communicated to subscribers 110, 112, and 114. Throughout the present disclosure, data publishers may be referred to as publishers and data subscribers may be referred to as subscribers.

Data publishers 104, 106, and 108 may provide data streams with various parameters. For example, the data streams may represent different types of data, different transmission rates, and data with different requirements (e.g., latency requirements). Data publishers 104, 106, and 108 may stream information using various protocols (e.g., Distributed Network Protocol 3 (DNP3), IEEE C37, General Object Oriented Substation Event (GOOSE)), and proprietary stream formats. The data streams may include data values that represent measurements or other conditions.

In various embodiments, communication system 102 may reorganize incoming data into data blocks destined for each subscriber 110, 112, and 114. The reorganized data blocks may then be delivered to subscribers 110, 112, and 114. In some embodiments, the data blocks may be delivered on a consistent schedule. In other embodiments, additional constraints, such as time constraints (latency, time-to-live), priority information, and packet size, may be utilized in addition to or in place of a fixed schedule.

Data blocks sent by communication system 102 to subscribers 110, 112, and 114 may, depending on the specific configuration of a specific embodiment, comprise data packets from multiple data publishers and from a span of time. By consolidating information from multiple publishers and a span of time into a single data block, the efficiency of system 100 may be improved. Such improvements may be particularly important in the event of an anomalous condition. In such conditions, devices may generate additional amounts of data, and such information may exceed the transmission capacity of system 100.

System 100 may also determine computed values repository 116 that other elements in system 100 may utilize. In certain embodiments, system 100 may be implemented in an electric power system. In such embodiments, data publishers 104, 106, and 108 may be embodied as devices that measure electrical parameters (e.g., voltages, currents, etc.), and subscribers 110, 112, and 114 may represent devices that utilize such data (e.g., as a logic controller, an intelligent electric device (“IED,” a protective relay) to monitor, protect, or automate the electric power system. A plurality of computed value repositories, which are shown as multiple blocks below computed values repository 116, may be provided. Each computed values repository may embody a distinct physical or logical device.

Computed values may be determined from various parameters monitored by data publishers 104, 106, and 108. Computed values may include, for example, power calculations, phase angle calculations, positive-, negative-, and zero-sequence currents, differential measurements, etc. Consolidating calculated values and making them available to various components in system 100 may reduce the need for redundant calculations, and may thus further increase the efficiency of system 100.

A data repository 118 may store historical information. For example, records of the data streams generated by data publishers 104, 106, and 108 may be archived by data repository 118. Further, computed values repository 116 may also be stored. The data available in data repository 118 may be made available to devices through system 100. Multiple data repositories, which are illustrated as multiple blocks below data repository 118, may be provided in various embodiments.

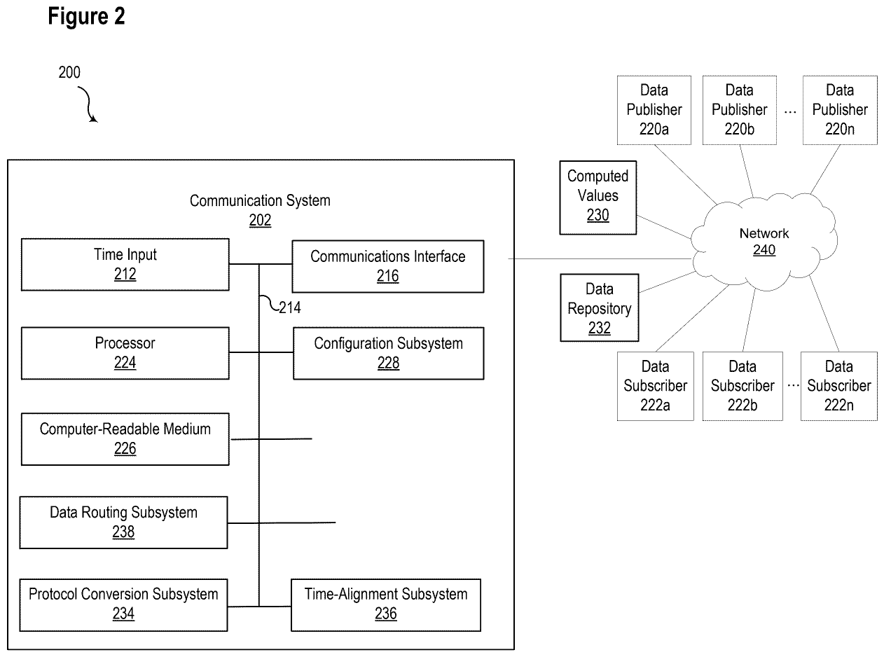

FIG. 2 illustrates a functional block diagram of a system 200 for routing data streams from a plurality of data publishers 220 to a plurality of data subscribers 222 consistent with embodiments of the present disclosure. Any number of data publishers (220a-220n) and any number of data subscribers (222a-222n) may be included in systems consistent with embodiments of the present disclosure. System 200 may be implemented using hardware, software, firmware, and/or any combination thereof. In some embodiments, system 200 may be embodied as a logic controller, an IED, a protective relay, or other types of devices. Certain components or functions described herein may be associated with other devices or performed by other devices. The specifically illustrated configuration is merely representative of one embodiment consistent with the present disclosure.

Communication system 202 includes a communications interface 216 to communicate with other devices, such as data publishers 220 and data subscribers 222. In various embodiments related to electric power systems, data publishers 220 and data subscribers 222 may be embodied as merging units, relays, IEDs, and/or other devices. In the illustrated embodiment, a network 240 connects communication system 202, data publishers 220, and data subscribers 222. In other embodiments, communications interface 216 may facilitate direct communication with data publishers 220 and data subscribers 222.

Communication system 202 may include a time input 212, which may be used to receive a time signal (e.g., a common time reference), allowing communication system 202 to apply a time stamp to data. In certain embodiments, a common time reference may be received via communications interface 216, and accordingly, a separate time input may not be required for time-stamping and/or synchronization operations. One such embodiment may employ the IEEE 1588 protocol.

In various embodiments, communication system 202 may process data streams received from the plurality of data publishers 220 as streams of timestamped data. A time signal from a time input 212 may be used to time-align values from the plurality of data publishers 220. Time-aligning the information may allow communication system 202 to respond to requests for previously published historic data for given time ranges, thus simplifying client application code.

Processor 224 processes communications received via communications interface 216 or time input 212. Processor 224 may operate using any number of processing rates and architectures. Processor 224 may perform various algorithms and calculations described herein. Processor 224 may be embodied as a general-purpose integrated circuit, an application-specific integrated circuit, a field-programmable gate array, and/or any other suitable programmable logic device. A data bus 214 may connect various components of communication system 202. A configuration subsystem 228 may allow an operator to configure various aspects of communication system 202, including criteria related to thresholds or parameters described above.

Instructions to be executed by processor 224 may be stored in computer-readable medium 226. Computer-readable medium 226 may comprise random access memory (RAM) and non-transitory memory. Computer-readable medium 226 may be the repository of software modules configured to implement the functionality described herein.

A data routing subsystem 238 may be configured to receive information from the plurality of data publishers 220, generate data blocks comprising information from the plurality of data publishers 220, and route the data blocks to the plurality of data subscribers 222. In various embodiments, data routing subsystem 238 may generate a new data block for each of the plurality data subscribers 222. As information arrives from the plurality of data publishers 220, it is analyzed and added to the data block for any relevant data subscriber 222. For example, if information from data publisher 220a arrives, and data subscriber 222b subscribes to the data, data routing subsystem 238 may add the data to a data block to be routed to data subscriber 222b. Data routing subsystem 238 may incorporate a plurality of messages to be routed to the same data subscriber 222 into a single data block. Data from distinct data publishers (e.g., data publishers 220a and 220b) may be combined in a data block.

A configuration subsystem 228 may be used to configure communication system 202. Such configuration may include routing information from the plurality of data publishers 220 to the plurality of data subscribers 222. Moreover, the configuration subsystem 228 may be used to specify constraints and/or parameters that constrain the communication of information by communication system 202. For example, data subscriber 222a may have a latency or TTL requirement that differs from data subscriber 222b. Such information may be provided to configuration subsystem 228, and delivery of data to each data subscriber may be scheduled to satisfy the applicable latency or TTL requirement.

A computed values subsystem 230 may calculate computed values that may be utilized by other elements in communication system 202. In certain embodiments, system 100 may be implemented in an electric power system. Computed values may be determined from various parameters monitored by data publishers 104, 106, and 108. Computed values may include, for example, power calculations, phase angle calculations, positive-, negative-, and zero-sequence currents, differential measurements, etc. Consolidating calculated values and making them available to various components in system 100 may reduce the need for redundant calculations and may thus further increase the efficiency of system 100.

A data repository subsystem 232 may store information received by communication system 202. Such information may include data streams generated by data publishers 220, which may be archived by data repository subsystem 232. Information in data repository subsystem 232 may be made available to other components in system 200 and/or to operators of system 200. Users may analyze data available from data repository subsystem 232 for post-event analysis or various other tasks.

A protocol conversion subsystem 234 may convert information between various protocols that may be used to communicate with system 200. In various embodiments, the plurality of data publishers may stream information using various standardized protocols (e.g., Distributed Network Protocol 3 (DNP3), IEEE C37, General Object Oriented Substation Event (GOOSE)), and proprietary stream formats. The plurality of data subscribers 222 may receive information using a variety of protocols. Protocol conversion subsystem 234 may convert information between the various protocols used by communication system 202. In one specific embodiment, all incoming data streams may be converted to a single protocol. In such an embodiment, outgoing communications may utilize the protocol to standardize communication and facilitate access to information within computed values subsystem 230 and/or data repository subsystem 232.

A time-alignment subsystem 236 may generate a time-aligned representation of information within the plurality of data streams. Time-alignment subsystem 236 may further increase the overall efficiency of system 200 by eliminating the need for redundant time-alignment by multiple devices. Although the plurality of data subscribers 222 may have the capability of time-aligning values within received data streams, communication system 202 may complete this task, thus reducing the burden on the plurality data subscribers 222.

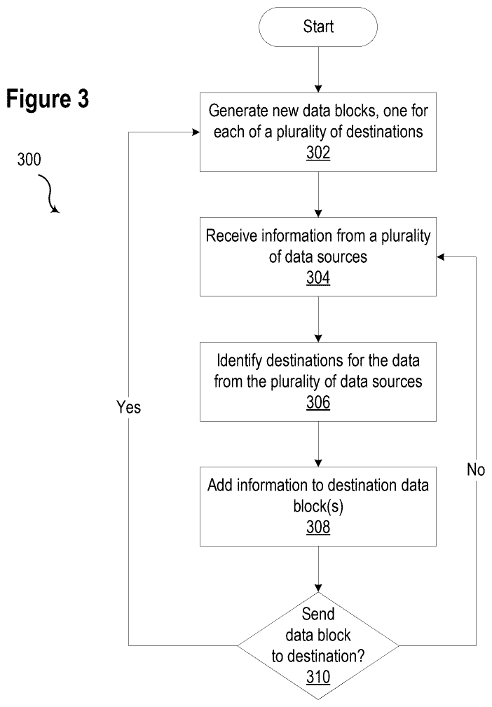

FIG. 3 illustrates a flow chart of a method 300 for routing data from a plurality of data publishers to a plurality of destinations consistent with embodiments of the present disclosure. In one specific embodiment, method 300 may be utilized in connection system 200, as illustrated in FIG. 2.

At 302, new data blocks, one for each of a plurality of destinations, may be generated. Each destination may represent a data subscriber. A separate data block may be generated for each destination. Data blocks may be generated in a format expected by the destination. The details associated with each data block (e.g., communication protocol, delivery schedule, packet size) may be determined by the requirements associated with each destination.

At 304, information from a plurality of data publishers may be received. Each of the plurality of data publishers may represent a type of information or a unique device. For example, in an electric power system, a plurality of merging units may generate a stream of current and voltage measurements at different locations in the system. In other examples, the type of information received may vary.

At 306, the destinations for the data from the plurality of data publishers may be identified. For example, if a group of data subscribers subscribes to a data stream, and information associated with the data stream is received, each subscribing device may be identified as a destination for the data.

At 308, the information received from the data publisher may be added to the data block for each destination. Data blocks may comprise a plurality of messages to be routed to the same destination or data subscriber. Incorporating a plurality of messages from multiple data publishers and/or over a span of time—as opposed to routing each message individually—may increase the efficiency of the network. Other operations to improve efficiency and/or decrease the burden on a receiving device may also be performed (e.g., time-aligning values added to the destination data block).

At 310, method 300 may determine whether to send a data block to a destination. If the data block is not sent to the destination, method 300 may return to 304. Data blocks may be transmitted based on a variety of conditions. For example, high-priority messages may result in immediate transmission. In this example, the high-priority message may be included with previously received lower-priority messages. In addition, data blocks may be transmitted on a schedule. A schedule may be determined based on timing parameters associated with the network and data. For example, a schedule may be utilized to maintain network latency below a threshold or to ensure that packets having a specific TTL are delivered in a timely manner. Certain embodiments may also consider message priority indicators in determining when to send a data block to a destination. For example, a message containing information about the detection of a fault in an electric power system may be given a high priority. The receipt of a high-priority message may trigger the sending of a packet despite the typical use of a schedule. As one of skill in the art will appreciate, a variety of other criteria for triggering the transmission of the data block may be utilized. If the data block is sent to the destination, method 300 may return to 302.

While specific embodiments and applications of the disclosure have been illustrated and described, it is to be understood that the disclosure is not limited to the precise configuration and components disclosed herein. Various modifications, changes, and variations apparent to those of skill in the art may be made in the arrangement, operation, and details of the methods and systems of the disclosure without departing from the spirit and scope of the disclosure.

What is claimed:

1. A communication system to route data between a plurality of data publishers and a plurality of data subscribers, comprising:
a communication interface configured to receive a plurality of data streams from the plurality of data publishers over time, each of the plurality of data streams comprising a plurality of data values; and
a data routing subsystem to:
generate a data block for at least one of the plurality of data subscribers;
identify within the plurality of data streams:
a first data value to be routed to the at least one of the plurality of data subscribers; and
a second data value to be routed to the at least one of the plurality of data subscribers;
add the first data value and the second data value to the data block; and
route the data block comprising the first data value and the second data value to the at least one of the plurality of data subscribers.

2. The communication system of claim 1, wherein the first data value and the second data value are comprised in data streams from distinct data publishers in the plurality of data publishers.

3. The communication system of claim 1, wherein the data routing subsystem is further configured to route the data block to the at least one of the plurality of data subscribers according to a schedule.

4. The communication system of claim 3, wherein the schedule is based at least in part on a latency requirement.

5. The communication system of claim 1, wherein the data routing subsystem is further configured to route the data block to the at least one of the plurality of data subscribers based on a priority associated with at least one of the plurality of data values.

6. The communication system of claim 1, wherein the plurality of data values comprises a plurality of electrical parameter measurements in an electric power system.

7. The communication system of claim 1, further comprising a computed values subsystem to:
determine a computed value based on the first value and the second value; and
make the computed value available to the plurality of data subscribers.

8. The communication system of claim 1, further comprising a data repository subsystem to:
generate a repository comprising the plurality of data streams from the plurality of data publishers over time; and
make the repository available to the plurality of data subscribers.

9. The communication system of claim 8, wherein the data repository subsystem is further configured to generate a time-aligned representation of values within the plurality of data streams.

10. The communication system of claim 1, further comprising a protocol conversion subsystem to:
receive at least one of the plurality of data streams in a first protocol; and
convert the plurality of data values in the first protocol to a second protocol.

11. A method of routing data between a plurality of data publishers and a plurality of data subscribers, comprising:
receiving a plurality of data streams from the plurality of data publishers over time, each of the plurality of data streams comprising a plurality of data values; and
generating a data block for one at least one of the plurality of data subscribers; and
identifying within the plurality of data streams:
a first value to be routed to the at least one of the plurality of data subscribers; and
a second value to be routed to the at least one of the plurality of data subscribers;
adding add the first value and the second value to the data block; and
routing the data block comprising the first value and the second value to the at least one of the plurality of data subscribers.

12. The method of claim 11, wherein the first value and the second value are comprised in data streams from distinct data publishers.

13. The method of claim 11, further comprising routing the data block to the at least one of the plurality of data subscribers according to a schedule.

14. The method of claim 13, wherein the schedule is based at least in part on a latency requirement.

15. The method of claim 11, further comprising routing the data block to the at least one of the plurality of data subscribers based on a priority associated with at least of the plurality of values.

16. The method of claim 11, wherein the plurality of data streams comprises a plurality of electrical parameter measurements in an electric power system.

17. The method of claim 11, further comprising:
determining a computed value based on the first value and the second value; and
making the computed value available to the plurality of data subscribers.

18. The method of claim 11, further comprising generating a repository comprising the plurality of data streams from the plurality of data publishers over time; and
making the repository available to the plurality of data subscribers.

19. The method of claim 11, further comprising generating a time-aligned representation of values within the plurality of data streams.

20. The method of claim 11, further comprising:
receiving at least one of the plurality of data streams in a first protocol; and
converting the plurality of data values in the first protocol to a second protocol.
